(19) United States
(12) Patent Application Publication
(10) Pub. No.: US 2016/0174302 A1
(43) Pub. Date: Jun. 16, 2016

(54) COATED GRAPHITE HEATER CONFIGURATION

(71) Applicant: MOMENTIVE PERFORMANCE MATERIALS INC., Waterford, NY (US)

(72) Inventor: Zhong-Hao LU, Twinsburg, OH (US)

(21) Appl. No.: 14/905,183

(22) PCT Filed: Jul. 10, 2014
(86) PCT No.: PCT/US14/46140

§ 371 Date: Jan. 14, 2016

Related U.S. Application Data
(60) Provisional application No. 61/846,386, filed on Jul. 15, 2013.

(51) Int. Cl. H05B 6/36

(52) U.S. Cl. CPC H05B 6/362

(57) ABSTRACT

A coated graphite heater. The heater has a configuration comprising a plurality of heating rungs having a major portion disposed substantially parallel to an upper surface of the heater so that the major portion is disposed horizontally. The heater configuration provides a heater that exhibits reduced thermal stress and/or reduced CTE mismatch stress particularly compared to designs having heating rungs with a major portion oriented perpendicular to the plane of the upper surface of the heater.

### CROSS-REFERENCE TO RELATED APPLICATION

This application claims priority to U.S. Provisional Application No. 61/846,386 filed on Jul. 15, 2013 which is incorporated herein in its entirety by reference.

### FIELD

The present invention relates to a graphite heater. In particular, the present invention relates to a coated graphite heater configuration suitable for a wide variety applications including, but not limited to, for heating a semiconductor wafer in a semiconductor processing device.

### BACKGROUND

In the fabrication of a semiconductor device or semiconductor material, a semiconductor wafer is processed in an enclosure defining a reaction chamber at a relatively high temperature above 1000° C., with the wafer being placed adjacent to or in contact with a resistive heater coupled to a power source. For a cylindrical heater, the wafer can be placed on a support and the support heated by the heater. In this process, the temperature of the semiconductor wafer is held substantially constant and uniform, varying in the range of about 1° C. to 10° C.

U.S. Pat. No. 5,343,022 discloses a heating unit for use in a semiconductor wafer processing process, comprising a heating element of pyrolytic graphite (“PG”) superimposed on a pyrolytic boron nitride base. The graphite layer is machined into a spiral or serpentine configuration defining the area to be heated, with two ends connected to a source of external power. The entire heating assembly is then coated with a pyrolytic boron nitride (“pBN”) layer. U.S. Pat. No. 6,410,172 discloses a heating element, wafer carrier, or electrostatic chuck comprising a PG element mounted on a pBN substrate, with the entire assembly being subsequently CVD coated with an outer coating of AlN to protect the assembly from chemical attacks.

Although graphite is a refractory material that is economical and temperature resistant, graphite is corroded by some of the wafer processing chemical environments, and it is prone to particle and dust generation. Due to the discontinuous surface of a conventionally machined graphite heater, the power density varies dramatically across the area to be heated. Moreover, a graphite body, particularly after machining into a serpentine geometry, is fragile and its mechanical integrity is poor. Accordingly, even with a relatively large cross sectional thickness, e.g., above about 0.1 inches as typical for semiconductor graphite heater applications, the heater is still extremely weak and must be handled with care. Furthermore, a graphite heater changes dimension over time due to annealing which induces bowing or misalignment, resulting in an electrical short circuit. It is also conventional in semiconductor wafer processing to deposit a film on the semiconductor which may be electrically conductive. Such films may deposit as fugitive coatings on the heater, which can contribute to an electrical short circuit, a change in electrical properties, or induce additional bowing and distortion.

One approach to improving the stability of graphite heaters is to coat the graphite body with a nitride such as boron nitride or provide boron nitride bridges between heating elements. These designs might still exhibit high stress from coefficient of thermal expansion (CTE) mismatch stress (between the graphite and boron nitride material) and thermal stress at elevated operating temperatures. High stress can result in early failure in the heating device.

### SUMMARY

The present invention provides a heater assembly having a configuration adapted to relieve thermal stress, CTE mismatch stress, or both such stresses in the heater.

In one aspect, the present invention provides a heater having an upper surface and a lower surface and comprising a plurality of heating rungs, where the heating rungs comprise a major portion oriented horizontal to a plane defined by the upper surface.

In another aspect of the invention, the heater assembly comprises a coated graphite body. The coated graphite body has an upper surface and a lower surface. The body may have a configuration defining a predetermined path defining a plurality of heating rungs wherein a major portion of each heating rung is oriented substantially parallel to the upper surface.

In an embodiment, the body is a graphite body coated with a coating selected from: a nitride; a carbide; a carbonitride; or an oxynitride of elements selected from a group consisting of B, Al, Si, Ga, refractory hard metals, transition metals, and rare earth metals; or a combination of two or more thereof.

In another embodiment, the coating of the graphite body is selected from: pyrolytic boron nitride (pBN), aluminum nitride, titanium aluminum nitride, titanium nitride, titanium aluminum carbonitride, titanium carbide, silicon carbide, and silicon nitride. In one embodiment the coating may be pyrolytic boron nitride.

In yet another embodiment, the body further comprises two halves connected in series, where each half has a configuration defining a predetermined path defining a plurality of heating rungs, wherein a major portion of each heating rung is oriented substantially parallel to the upper surface.

In one embodiment, the body is a cylindrical body.

In an embodiment of the invention, each heating rung has substantially the same width. In another embodiment, the width of at least one heating rung may be narrower than the width of at least one other heating rung. The width of the uppermost heating rung at the top of the upper surface of the body may be narrower than at least one other heating rung. In another embodiment, the width of the uppermost heating rung at the top of the upper surface of the body is less than or equal to half the width of at least one other heating rung.

In another embodiment the coefficient of thermal expansion (CTE) mismatch stress is less than the flexural strength of the material that forms the heater body.

In another aspect of the invention, the heater assembly comprises a coated graphite body. The coated graphite body has an upper surface and a lower surface. The body may have a configuration defining a predetermined path defining a plurality of heating rungs wherein a major portion of each heating rung is oriented substantially parallel to the upper surface. The width of at least one heating rung is narrower than the width of another heating rung.

In another aspect of the invention, the heater assembly comprises a coated graphite body. The coated graphite body has an upper surface and a lower surface. The body may have a configuration defining a predetermined path defining a plurality of heating rungs wherein a major portion of each heating rung is oriented substantially parallel to the upper surface. The width of the heating rung at the top of the upper surface of the body is less than or equal to half the width of the other heating rungs

### BRIEF DESCRIPTION OF THE DRAWINGS

FIG. 1 is a perspective view of a heater in accordance with an embodiment of the present invention;

FIG. 2 is a top plan view of the heater of FIG. 1;

FIG. 3 is a front plan view of the heater of FIG. 1;

FIG. 4 is a side plan view of the heater of FIG. 1; and

FIG. 5 is a perspective view of a heater embodying comparative Example 1.

The drawings are not to scale unless otherwise noted. The drawings are for the purpose of illustrating aspects and embodiments of the present invention and are not intended to limit the invention to those aspects illustrated therein. Aspects and embodiments of the present invention can be further understood with reference to the following detailed description.

### DETAILED DESCRIPTION

The present invention provides a heater comprising a graphite body coated with one or more layers of a nitride, a carbide, a carbonitride, an oxynitride, or a combination of two or more thereof.

The heater comprises a graphite body having a configuration defining a predetermined path defining a plurality of heating rungs. The heater can be an integral body where the path can be a continuous path comprising a plurality of heating rungs. In one embodiment, the heater comprises a graphite body comprising two halves connected in series, where each half comprises a plurality of heating rungs in a predetermined configuration.

In accordance with aspects of the invention, the heater body comprises an upper surface, a lower surface, and the body has a configuration defining a predetermined path defining a plurality of heating rungs, where the heating rungs have a major portion that is oriented substantially parallel to the upper surface of the body. In one embodiment, the body comprises two halves connected in series, where each half has a configuration defining a predetermined path defining a plurality of heating rungs, where the heating rungs have a major portion oriented substantially parallel to the upper surface of the body.

By providing a configuration with the major portion of the heating rungs oriented substantially parallel to the upper surface of the body, the heater body has a larger cross-sectional area that allows the thermal expansion to be spread over the entire length of the heating rungs, which has been found to reduce the stress concentration over the heater body. Such a configuration also has been found to reduce the stress in both the graphite body substrate and the coating layers. In one embodiment, the coefficient of thermal expansion (CTE) mismatch stress is less than the flexural strength of the graphite.

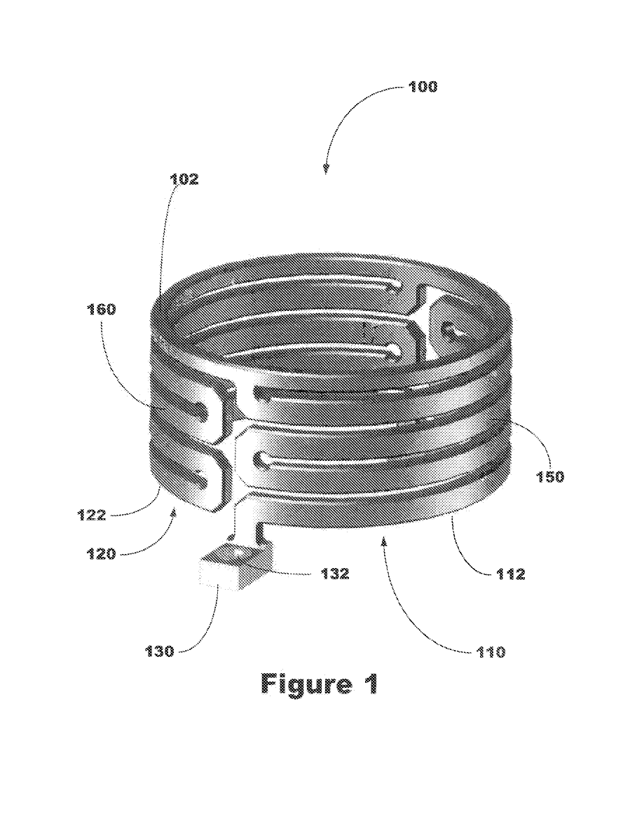

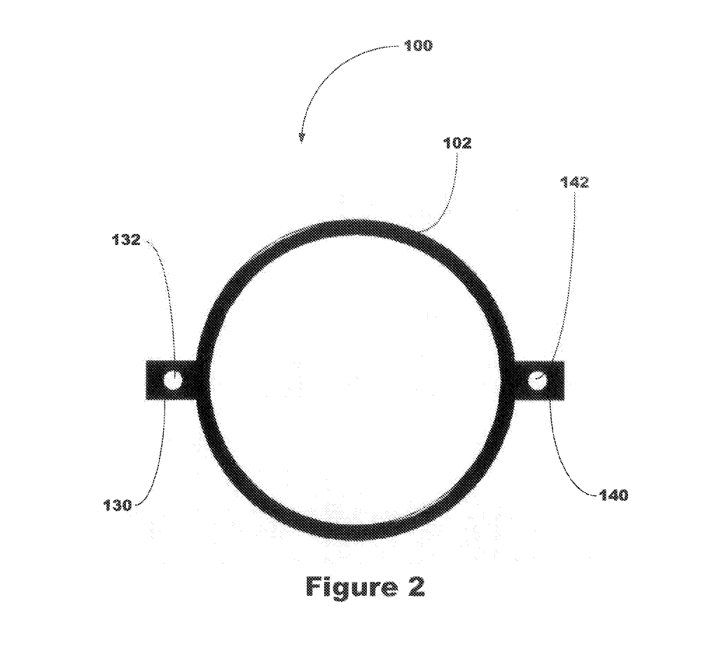

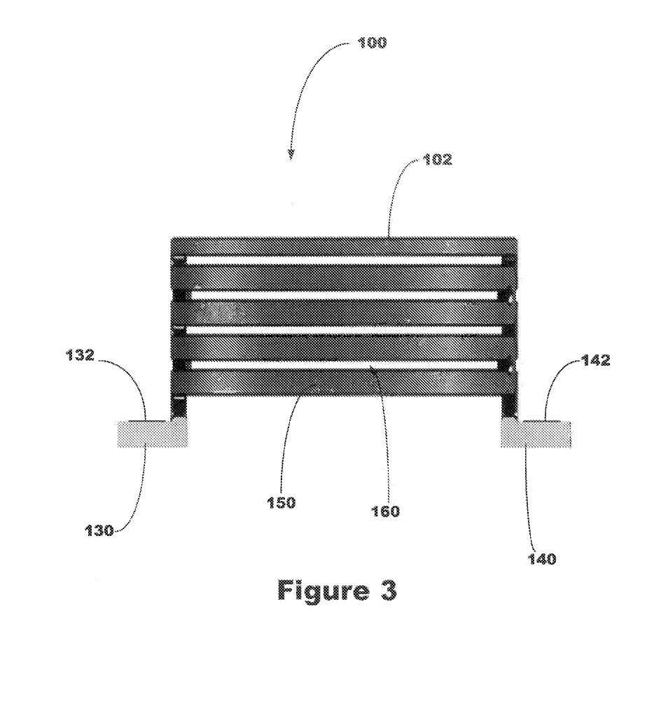

FIGS. 1-4 illustrate an embodiment in accordance with aspects of the present technology. The heater 100 comprises a first half 110 and a second half 120. The first half extends from a terminal 130, and the second half extends from a terminal 140. The terminals 130 and 140 include terminal connecting holes 132 and 142, respectively, which are points of attachment for an electrical power source to provide electrical current to the heater.

The heater 100 is illustrated as a cylindrical body comprising an upper surface 102. Each half, 110 and 120, defines a bottom surface 112 and 122, respectively. Each half of the heater body 100 is machined into a predetermined path defining a plurality of heater rungs 150 and 160. In FIGS. 1-4, the paths are provided in a serpentine arrangement with a major portion of the heating rung 150, 160 (or path) being oriented parallel with the upper surface of the heater, and a minor portion defining the turn in the path. As illustrated in FIGS. 1, 2, and 4, the respective serpentine pattern extends linearly and vertically from each terminal and then turns to form the major portions oriented horizontal and parallel to the plane of the upper surface of the heater.

It will be appreciated that the electrical flow path of the graphite body may form any appropriate pattern, including, but not limited to, a spiral pattern, a serpentine pattern, a helical pattern, a zigzag pattern, a continuous labyrinthine pattern, a spirally coiled pattern, a swirled pattern or a randomly convoluted pattern. Additionally, the heater body can be provided in any suitable shape as desired for a particular purpose or intended application.

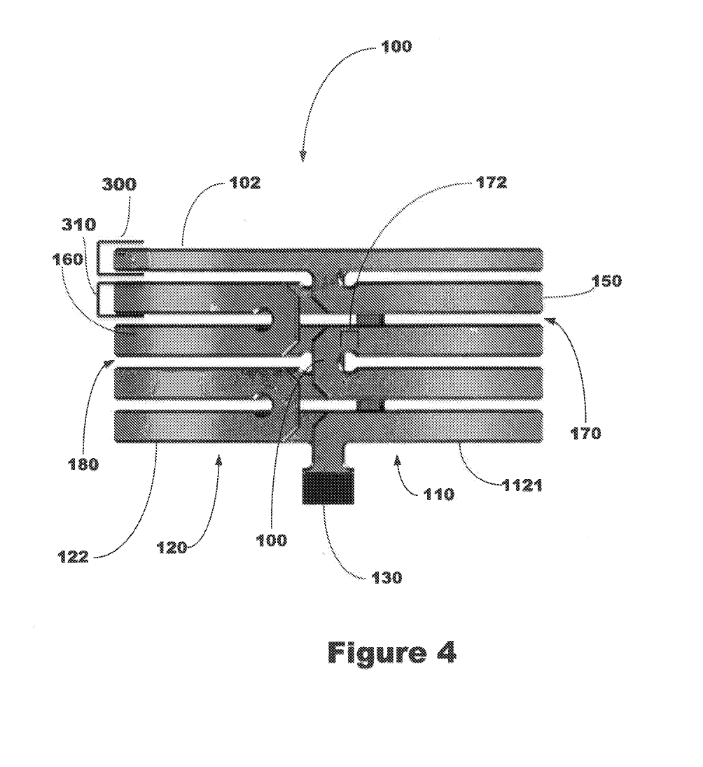

In the embodiment of FIG. 4, the width 300 of the uppermost heating rung at the top of the upper surface of the body is narrower than the width 310 of the other heating rungs. In one embodiment, the width 300 is less than or equal to half the width 310.

As illustrated, there is a gap or space 170, 180 between successive heating rungs. In one embodiment, the gap can be uniform between successive heating rungs including at the turn. In another embodiment, the gap defined near the turn of the serpentine path can be provided such that it is sized to have one or more dimensions larger than a dimension of the gap between the major portions of the heating rungs. For example, the height or width of the gap near the turn can be larger than the gap between the major portions of the heating rungs. As shown in FIGS. 1, 3, and 4, the gap 172 near the turn of the path can be provided with a geometric shape including, but not limited to, a rectangle, a square, a circle, a triangle, a pentagon, a hexagon, a heptagon, etc. The larger gaps 172 can taper or lead to the gap between the heating rungs. As illustrated in FIGS. 1, 3, and 4, the gap 172 near the turn of the serpentine path is circular to provide a “keyhole” gap. The present design with the relatively large cross sectional area provided by arranging the heating rungs with the major portion oriented horizontally to the plane of the upper surface of the heater allows for the inclusion of the larger gap near the turn of the serpentine path. The larger gaps near the turns can further reduce the thermal stress of the heater.

The width of the heating rung is not particularly limited. In one embodiment each heating rung may have substantially the same width. In another embodiment, the width of two or more heating rungs can be different or varied from one another. For example, the width of at least one heating rung may be narrower than the width of at least one other heating rung. In one embodiment, the uppermost heating rung at the top of the upper surface of the body may be narrower than at least one other heating rung. For example, the width of the uppermost heating rung may be narrower than the width of the heating rung directly below it. The width of the uppermost rung may be narrower than each of the other rungs, and each of the other rungs may have the same or different widths. In one embodiment, the width of each heating rung is different and decreases from the lowest rung to the uppermost rung. In another embodiment, the width of the uppermost heating rung may be less than or equal to half the width of at least one other heating rung. For example, the width of the uppermost heating rung may be less than or equal to half the width of the heating rung directly below.

In one embodiment one rung has a width that is about 0.5 times the width of another rung; about 0.4 times the width; about 0.3 times the width; about 0.2 times the width; even about 0.1 times the width of another rung. In another embodiment, one rung has a width that is about 0.05 to about 0.5 times the width of another rung; about 0.1 to about 0.4 times the width; even about 0.15 times to about 0.3 times the width of another rung.

Varying the width of the heating rungs has been found to impact the power density. For example, decreasing the width of the uppermost heating rung relative to the width of the other heating rungs increases the power density at the top of the heater. When the width of the uppermost heating rung is less than or equal to half the width of the heating rung directly below it, there is an increase in the power density at the top of the heater. Generally, it has been found that the change in power density can be calculated using the below formula:

width ratio=1/2\sqrt{power density ratio}

Thus, a width ratio of about 0.466 results in a power density ratio of 1.15, which means that the power density is increased by about 15%. Thus, varying the width of the heating rungs allows for controlling the power density of the heater.

The thickness of the graphite form may be determined from electrical calculations on the finished part and dimensional constraints of the heater such as, for example, inner and outer diameter. Fundamental calculations for the finished heater electrical resistance are known in the art, i.e., based on the length, the width, and the thickness of the serpentine electrical path, with the thickness of the electrical path being designed in to the graphite base.

The graphite body is provided with at least a substantially continuous coating layer of a sufficient thickness to provide the desired corrosion resistance as well as structural integrity and support in the machining step. In one embodiment, the coating layer encapsulates substantially all the exposed surfaces of the graphite base body. In another embodiment of the process of the invention, the coating layer simply covers the top or outer surface of the graphite base body for corrosion resistance and structural support.

In one embodiment, the coating layer has a thickness of 0.005 inches to 0.10 inches. In a second embodiment, this coating layer is about 0.01 inches to 0.05 inches. In a third embodiment, the coating layer has a thickness of less than about 0.02 inches. In yet a fourth embodiment, the coating layer is a flat solid substantially continuous surface layer of pBN having a thickness in the range of about 0.01 inches to about 0.03 inches.

The coating layer of the graphite body comprises one or more of a nitride, carbide, carbonitride or oxynitride of elements selected from a group consisting of B, Al, Si, Ga, refractory hard metals, transition metals, and rare earth metals, or complexes and/or combinations thereof. Examples include pyrolytic boron nitride (pBN), aluminum nitride, titanium aluminum nitride, titanium nitride, titanium aluminum carbonitride, titanium carbide, silicon carbide, and silicon nitride.

In a one embodiment, the coating layer comprises pBN. In a second embodiment, the layer comprises AlN. In a third embodiment, the coating layer comprises a complex of AlN and BN. In a fourth embodiment, the coating layer comprises a composition of pyrolytic boron nitride (PBN) and a carbon dopant in an amount of less than about 3 wt % such that its electrical resistivity is smaller than 10¹⁴ Ω-cm. In yet a fifth embodiment, the coating layer comprises an aluminum nitride wherein a small amount of Y₂O₃ is added, e.g. in amount of 5 wt % relative to 100 wt % of aluminum nitride. Both pBN and AlN have excellent insulating and conducting properties and can be easily deposited from the gaseous phase. They also have a high temperature stability. Additionally, they have a different color (white) than the pyrolytic graphite base (black) such that in the step of forming the electrical patterns, the coating layer can be easily visually distinguished from the patterns. In still another embodiment the coating can be silicon carbide (SiC). In yet another embodiment, the coating can be a tantalum carbide (TaC).

In one embodiment, the heater comprises a single coating of pBN. In one embodiment, the single coating of pBN is provided at a thickness in the range of about 0.01 to about 0.04 inches.

Different methods can be used to deposit the coating layer or layers onto the graphite body/substrate. In one embodiment, at least one of the layers can be applied through physical vapor deposition (PVC), wherein the coating material, e.g. boron nitride and/or aluminum nitride is/are transferred in vacuum into the gaseous phase through purely physical methods and are deposited on the surface to be coated. A number of method variants can be used. In one embodiment, the coating material is deposited onto the surface under high vacuum, wherein it is heated to transition either from the solid via the liquid into the gaseous state or directly from the solid into the gaseous state using electric resistance heating, electron or laser bombardment, electric arc evaporation or the like. Sputtering can also be used, wherein a solid target which consists of the respective coating material is atomized in vacuum by high-energy ions, e.g. inert gas ions, in particular argon ions, with the ion source being e.g. an inert gas plasma. Finally, a target which consists of the respective coating material can also be bombarded with ion beams under vacuum, be transferred into the gaseous phase and be deposited on the surface to be coated.

The above-mentioned PVD methods can also be combined and at least one of the layers can be deposited e.g. through plasma-supported vapor deposition.

Alternatively in one embodiment of the invention or as an additional coating layer, one of the layers can be deposited through chemical vapor deposition (CVD). In contrast to the PVD methods, the CVD method has associated chemical reactions. The gaseous components produced at temperatures of approximately 200 to 2000° C. through thermal, plasma, photon or laser-activated chemical vapor deposition are transferred with an inert carrier gas, e.g. argon, usually at under-pressure, into a reaction chamber in which the chemical reaction takes place. The solid components thereby formed are deposited onto the graphite body to be coated. The volatile reaction products are exhausted along with the carrier gas.

In one embodiment, the graphite body is coated with a layer of pyrolytic boron nitride via a CVD process as described in U.S. Pat. No. 3,152,006, the disclosure of which is herein incorporated by reference. In the process, vapors of ammonia and a gaseous boron halide such as boron trichloride (BCl₃) in a suitable ratio are used to form a boron nitride deposit on the surface of the graphite base.

In yet another embodiment, at least one of the layers can also be deposited using thermal injection methods, e.g. by means of a plasma injection method. Therein, a fixed target is heated and transferred into the gaseous phase by means of a plasma burner through application of a high-frequency electromagnetic field and associated ionization of a gas, e.g., air, oxygen, nitrogen, hydrogen, inert gases etc. The target may consist, e.g. of boron nitride or aluminum nitride and be transferred into the gaseous phase and deposited on the graphite body to be coated in a purely physical fashion. The target can also consist of boron and be deposited as boron nitride on the surface to be coated through reaction with the ionized gas, e.g., nitrogen.

In another embodiment, a thermal spray process is used. i.e., a flame spray technique is used wherein the powder coating feedstock is melted by means of a combustion flame, usually through ignition of gas mixtures of oxygen and another gas. In another thermal spray process called arc plasma spraying, a DC electric arc creates an ionized gas (a plasma) that is used to spray the molten powdered coating materials in a manner similar to spraying paint. In yet another embodiment, the coating material is applied as a paint/spray and sprayed onto the graphite body with an air sprayer.

In another embodiment for a relatively “thick” coating layer, i.e., of 0.03 inches or thicker, the coating material is applied simply as a liquid paint and then dried at sufficiently high temperatures to dry out the coating. In one embodiment wherein BN is used as a coating, the BN over-coated graphite structure is dried at a temperature of at least 75° C., and in one embodiment, of at least 100° C. to dry out the coating.

In one embodiment after a coating process as described above, the coated graphite structure is heated to a temperature of at least 500° C. to further bond the nitride coating onto the graphite body.

Other coating processes can be used depending on the material being coated. For example, TaC can be deposited by CVR (chemical vapor reaction) methods, whereby the top layer of the graph it is converted to the carbide.

Coating the Patterned Graphite Body with a Substantially Continuous Overcoat: In this step, the patterned graphite body is coated with at least another layer for enhanced corrosion resistance against the wafer processing chemical environment. The protective overcoat layer may cover both the top and the bottom surfaces of the patterned graphite body, or the overcoating layer may simply provide a protective layer covering any exposed graphite.

The outer coat may be of the same material, or of a different material from the first coating layer described in the previous sections. As with the first coating layer, the outer coat layer covering the patterned graphite body may comprise at least one of a nitride, carbide, carbonitride or oxynitride of elements selected from a group consisting of B, Al, Si, Ga, refractory hard metals, transition metals, and rare earth metals, or complexes and/or combinations thereof. In one embodiment, the outer coat layer comprises pBN, AlN, SiC, or SiN.

The overcoat layer can be applied using the same techniques as with the first coating layer, or it can be applied using any other techniques known in the art as described in the previous sections, including but not limited to PVD, CVD, powder coating via thermal injection, thermal spraying, arc spraying, painting, and air spraying.

In one embodiment, the overcoat layer has a thickness of 0.005 inches to 0.20 inches. In another embodiment, from about 0.01 inches to 0.10 inches. In a third embodiment, the overcoat layer has a thickness of less than about 0.05 inches. In yet a fourth embodiment, the overcoat layer is a flat solid substantially continuous surface layer of pBN having a thickness in the range of about 0.01 inches to about 0.03 inches.

In one embodiment wherein pBN is used for the overcoat layer, the layer thickness is optimized to promote thermal uniformity, taking into advantage the high degree of thermal conductivity anisotropy inherent in pBN. In yet another embodiment, multiple overcoat layers are employed, pBN as well as pyrolytic graphite, to promote thermal uniformity.

The configuration of the heater of the present invention is adapted to relieve thermal stress, CTE mismatch stress or both such stresses on the heater. Orienting a major portion of each heater rung substantially parallel to the upper surface of the heater has been found to relieve thermal stress and CTE mismatch stress when compared to orienting the heater rungs substantially perpendicular to the upper surface. (See Table 1). The configurations provide, in one embodiment, a heater having a CTE mismatch stress that is less than the flexural strength of the material forming the heater body. In one embodiment, the CTE mismatch stress of the heater of the present invention has been found to be less than the flexural strength of the graphite that forms the heater body.

Forming Electrical Contacts. In this final step, electrical contacts are machined through the top coating layer to expose the graphite at contact locations for connection to an external power source. Alternatively, electrical contact extensions can be machined into the graphite base at the outset before the final coating process, or added prior to the over coating operation.

The heater of the present invention may be used for different applications particularly semiconductor processing applications as a wafer carrier. It has been found that the mechanical strength of the heater of the present invention to be dramatically improved relative to the strength of a conventional graphite heater.

In semiconductor applications, wafers of different size and/or shape are typically processed. Therefore, it will be appreciated that the heater in the broad practice of the present invention may be of any suitable size and shape/conformation, as required for the specific use or application envisioned. The heater may be of a cylindrical shape, a flat disk, a platen, and the like. It may have dimensions of about 2 to 20 inches in its longest dimension (e.g., diameter, length, etc.) and 0.05″ to 0.50″ inches thick. In one embodiment, it may be of a disk having a dimension of 2″ long×2″ wide×0.01″ mm thick. In one embodiment of a cylinder, the heater has dimensions of 2″ to 20″ in inside diameter, 0.10″ to 0.50″ wall, and 2″ to 40″ long.

All citations referred herein are expressly incorporated herein by reference.

### Examples

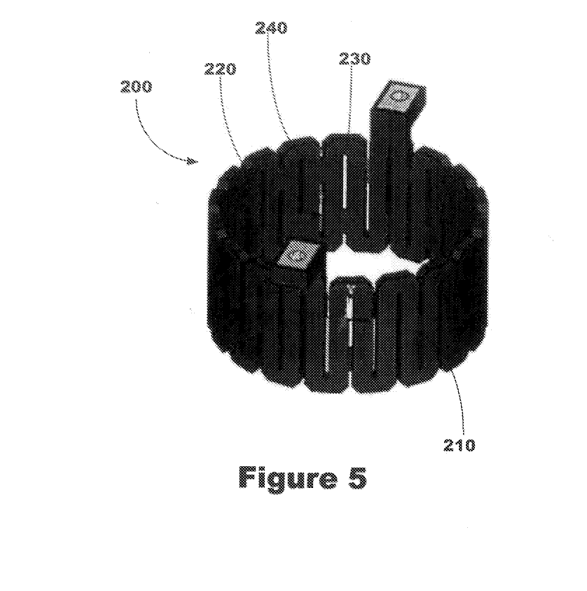

Properties of a heater in accordance with aspects and embodiments of the described technology are evaluated and compared to properties of prior heater designs. Example 1 is a heater represented by FIGS. 1-4. Comparative Example 1 is a heater having a configuration as illustrated in FIG. 5. The heater 200 in FIG. 5 is formed from a graphite body and coated with pBN. The heater includes two halves in parallel to one another. The paths extend from the terminals in a serpentine path comprising heating rungs having a major portion 210 oriented perpendicular to upper surface of the heater. The heater includes a gap or space 220 between turns 230 of the serpentine path, and includes a bridge 240 formed by pyrolytic boron nitride between the heating rungs. Comparative Example 2 is similar to Comparative Example 1 except that the pyrolytic boron nitride bridges have been removed in Comparative Example 2.

Thermal stress of the heaters upon heating from 20° C. to 1500° C. with fixed terminals at 20° C. is evaluated using Ansys, a finite element analysis software tool. CTE mismatch stress is evaluated when the heater is cooled from 1800° C. to 20° C. using Ansys for the finite element analysis and the one-dimensional stress equation for the theoretical value.

Table 1 includes properties of the various heater designs.

TABLE 1

| | Comparative | Comparative | | |
|---|---|---|---|---|
| | Example 1 | Example 2 | Example 1 | Example 2 |
| Graphite Width | 5.93 | 5.93 | 4.89 | 4.89 |
| (mm) | | | | |
| Graphite Thickness | 3.60 | 3.60 | 6.08 | 6.08 |
| (mm) | | | | |
| PBN Coating | 1.0 | 1.0 | 1.0 | 0.75 |
| Thickness (mm) | | | | |
| CTE Mismatch | 32.5 | 32.5 | 29.0 | 25.0 |
| Stress (MPa) - FEA | | | | |
| CTE Mismatch | 34.3 | 34.3 | 31.1 | 26.2 |
| Stress (MPa) - | | | | |
| Theoretical | | | | |
| Thermal Stress | 29 | 4.5 | 1.8 | 1.6 |
| (MPa) - PEN | | | | |
| Coating | | | | |
| Thermal Stress | 2.3 | 1.1 | 0.6 | 0.6 |
| (MPa) - Graphite | | | | |

As illustrated in Table 1, the present heater configurations can provide a design having reduced thermal stress and reduced CTE mismatch stress compared to prior heater designs. This is seen even as the thickness of the coating layer encapsulating the graphite is reduced.

Embodiments of the invention have been described above and modifications and alterations may occur to others upon the reading and understanding of this specification. The claims as follows are intended to include all modifications and alterations insofar as they come within the scope of the claims or the equivalent thereof.

What is claimed is:

1. A heater comprising:
a coated graphite body, the body comprising:
an upper surface;
a lower surface; and
a configuration defining a predetermined path defining a plurality of heating rungs, wherein a major portion of each heating rung is oriented substantially parallel to the upper surface.

2. The heater of claim 1, wherein the graphite body is coated with a coating selected from: a nitride; a carbide; a carbonitride; or an oxynitride of elements selected from a group consisting of B, Al, Si, Ga, refractory hard metals, transition metals, and rare earth metals; or a combination of two or more thereof.

3. The heater of claim 2, wherein the coating is selected from: pyrolytic boron nitride (pBN), aluminum nitride, titanium aluminum nitride, titanium nitride, titanium aluminum carbonitride, titanium carbide, silicon carbide, and silicon nitride.

4. The heater of claim 3, wherein the coating is pyrolytic boron nitride.

5. The heater of claim 1, wherein the body further comprises two halves connected in series, where each half has a configuration defining a predetermined path defining a plurality of heating rungs, wherein a major portion of each heating rung is oriented substantially parallel to the upper surface.

6. The heater of claim 1 wherein the body is a cylindrical body.

7. The heater of claim 1, wherein each heating rung has substantially the same width.

8. The heater of claim 1, wherein the width of at least one heating rung is narrower than the width of at least one other heating rung.

9. The heater of claim 8, wherein the width of an uppermost heating rung at the top of the upper surface of the body is narrower than at least one other heating rung.

10. The heater of claim 9, wherein the width of an uppermost heating rung at the top of the upper surface of the body is less than or equal to half the width of at least one other heating rung.

11. The heater of claim 1, wherein the coefficient of thermal expansion (CTE) mismatch stress is less than the flexural strength of the graphite.

12. The heater of claim 1, wherein each heating rung forms a serpentine pattern, and there is a gap between each heating rung, wherein at least a portion of the gap between at least two heating rungs is a keyhole gap.

13. A heater comprising:
a coated graphite body, the body comprising:
an upper surface;
a lower surface;
a configuration defining a predetermined path defining a plurality of heating rungs, wherein a major portion of each heating rung is oriented substantially parallel to the upper surface; and
wherein the width of at least one heating rung is narrower than the width of at least one other heating rung.

14. The heater of claim 13, wherein the width of an uppermost heating rung at the top of the upper surface of the body is narrower than at least one other heating rung.

15. The heater of claim 14, wherein the width of an uppermost heating rung at the top of the upper surface of the body is less than or equal to half the width of at least one other heating rung.

16. The heater of claim 13, wherein the graphite is coated with a coating selected from: a nitride; a carbide; a carbonitride; or an oxynitride of elements selected from a group consisting of B, Al, Si, Ga, refractory hard metals, transition metals, and rare earth metals; or a combination of two or more thereof.

17. The heater of claim 13, wherein the coating is selected from: pyrolytic boron nitride (pBN), aluminum nitride, titanium aluminum nitride, titanium nitride, titanium aluminum carbonitride, titanium carbide, silicon carbide, and silicon nitride.

18. The heater of claim 17, wherein the coating is pyrolytic boron nitride.

19. The heater of claim 13, wherein the body further comprises two halves connected in series, where each half has a configuration defining a predetermined path defining a plurality of heating rungs, wherein a major portion of each heating rung is oriented substantially parallel to the upper surface.

20. The heater of claim 13, wherein the coefficient of thermal expansion (CTE) mismatch stress is less than the flexural strength of the graphite.

21. A heater comprising:
a coated graphite body, the body comprising:
an upper surface;
a lower surface;
a configuration defining a predetermined path defining a plurality of heating rungs, wherein a major portion of each heating rung is oriented substantially parallel to the upper surface; and
wherein the width of the heating rung at the top of the upper surface of the body is less than or equal to half the width of at least one other heating rung.

22. The heater of claim 22, wherein the coefficient of thermal expansion (CTE) mismatch stress is less than the flexural strength of the graphite.
